(19) United States
(12) Patent Application Publication
(10) Pub. No.: US 2003/0050787 A1
(43) Pub. Date: Mar. 13, 2003

(54) Application status system and method

(76) Inventors: William Darin Hornsby, Richmond, VA (US); Elena Marie Horvath, Glen Allen, VA (US); Caroline M. Pendleton-Hillmar, Richmond, VA (US); Lawrence Keith MacGregor, Glen Allen, VA (US); David Thomson Harkess, Chesterfield, VA (US)

Correspondence Address: BAKER & MCKENZIE, 805 THIRD AVENUE, NEW YORK, NY, 10022, US

(21) Appl. No.: 09/948,330

(22) Filed: Sep. 7, 2001

(51) Int. Cl. G06F 17/60

(52) U.S. Cl. 705/1

(57) ABSTRACT

System and method for managing a status of an application previously submitted by an applicant. Call information associated with a call is received and a determination is made whether a reason for the call is to inquire about the status of the previously submitted application based on the call information. Status information associated with the applicant is then retrieved and the applicant is automatically provided from the retrieved status information a message indicating the status of the previously submitted application if it is determined that the reason for the call is to inquire about the status of the previously submitted application.

### FIELD

The present application relates to an application status system and method and, more particularly, to a system and method that automatically provides to applicants via automated messages information about the status of a previously submitted application.

### BACKGROUND

Voice response units enable users to access information using a conventional telephone. The interaction between the users and the voice response unit includes various voice prompts output by the voice response unit and responses thereto, for example, via the telephone keypad, by the user. Voice response units are used by service providers, such as banks and credit card companies, to fully or partially automate telephone call answering or responding to queries. Typically a voice response unit provides the capability to play voice prompts including recorded voice segments or speech synthesized from text and to receive responses thereto. The voice prompts are generally organized in the form of voice menus invoked by state tables. A state table can access and play a voice segment or synthesize speech from given text. The prompts are usually part of a voice application that is designed to, for example, allow a user to query information associated with their various accounts.

Further, voice response units are used in a variety of applications today to resolve customer problems and questions in conjunction with customer service representatives. In a financial service industry, such voice response units often provide users general information via one or more automated messages. Usually, the user is also given the option to either bypass an automated message or after the automated message has concluded to interact with a customer service representative in order to receive more detailed information tailored to an account of the user.

For example, a user may submit a credit card, a debit card, a smart card and/or a loan application, for example, to a credit card company. Thereafter, the applicant contacts the credit card company to inquire about the status of the application, such as whether the application has been received and approved, and when the applicant can expect to receive a credit card. The applicant receives very little information, if any, from automated messages, but rather must speak with a customer service representative to receive information about the status of the application that was previously submitted. As a result, since such applicants would rather speak with a customer service representative because the information provided via automated messages is not sufficient and/or because of lack of patience navigating through several automated messages to find out the necessary information, there is an overload of calls that must be serviced by customer service representatives. Consequently, companies, such as credit card companies, incur tremendous expenses in having to handle these calls with customer service representatives, as opposed to having the calls handled solely through the voice response unit.

Accordingly, a need exist for a system and method whereby the number of inquiries to customer service representatives are mitigated due to detailed information being automatically provided to an applicant via automated messages regarding the status of a previously submitted application. Particularly, there is a need for a system and method that predicts the reason for a user calling to be to inquire about the status of a previously submitted application and for automatically providing to that user via automated messages status information associated with the previously submitted application.

### SUMMARY OF THE INVENTION

An aspect of the present application provides for a method for managing a status of an application previously submitted by an applicant. The method includes receiving call information associated with a call, determining whether a reason for the call is to inquire about the status of the previously submitted application based on the call information, retrieving status information associated with the applicant, and automatically providing to the applicant from the retrieved status information a message indicating the status of the previously submitted application if it is determined that the reason for the call is to inquire about the status of the previously submitted application.

A further aspect of the present application provides for a system for managing a status of a previously submitted application. The system includes a memory unit for storing status information associated with the previously submitted application, a response unit operable to receive call information associated with a call, and a determination unit connected to the response unit and to the memory unit, the determination unit operable to receive the call information from the response unit for determining a reason for the call, the reason being to inquire about the status of the previously submitted application, to retrieve the status information associated with the previously submitted application from the memory unit, and to automatically provide through the response unit a message indicating the status of the previously submitted application.

A still further aspect of the present application provides for a method for providing status information to a customer calling into a voice response unit. The method includes receiving a customer identifier that identifies the customer, determining whether a reason for the call is to inquire about a status of a previously submitted application, retrieving status information of the customer identified by the customer identifier, providing a status of an account according to the retrieved status information if it is determined that the reason for the call is to inquire about the status of the previously submitted application.

### BRIEF DESCRIPTION OF THE DRAWINGS

FIG. 1 illustrates an exemplary application status system of the present application;

FIG. 2 illustrates an exemplary flow diagram for providing status information to an applicant of the present application; and

FIG. 3 illustrates another exemplary flow diagram for providing status information to an applicant of the present application.

### DETAILED DESCRIPTION

The exemplary embodiments of the present application are explained with reference to a customer, referred to herein as an applicant, submitting a credit card application and thereafter contacting the credit card company for information regarding the status of the previously submitted application. The present application, however, is not limited to credit card applications, credit cards and credit card companies, rather, other applications managed or owned by various companies can be submitted and inquired about, such as debit card applications and smart card applications, and their associated cards, and loan applications.

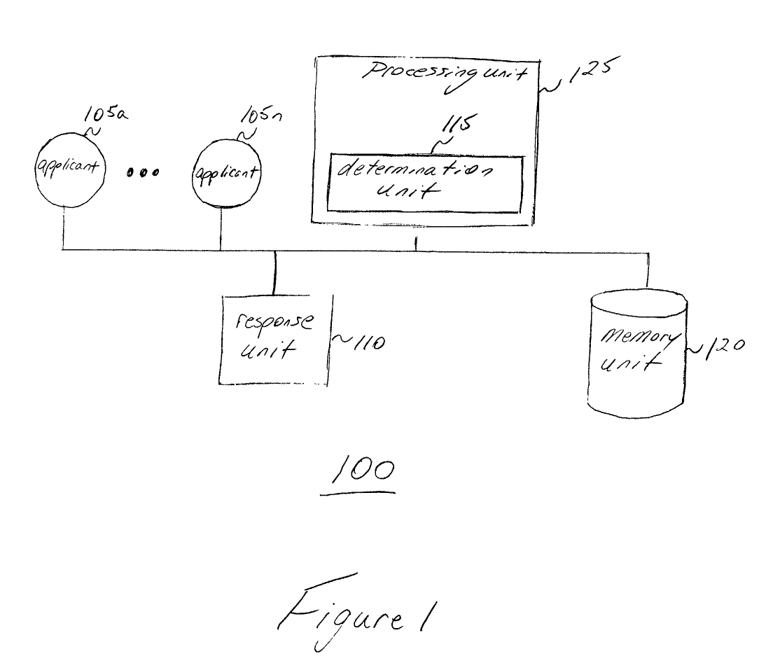

In FIG. 1, an exemplary application status system 100 is shown. Application status system 100 includes one or more applicants 105a . . . 105n, response unit 110, processing unit 125 including determination unit 115 and memory unit 120. In an exemplary embodiment, applicants 105a . . . 105n are individuals using communication devices, such as wired or wireless telephones and/or network connections, for example, Internet connections, via a wireless or wired transmission link to transmit information to and to receive information from response unit 110. Other communication devices can be used by applicants 105a . . . 105n as well. Further, memory unit 120 can include various types of memory storage devices, for example, one or more databases. Memory unit 120 can store, for example, status information associated with applications. The components of FIG. 1 may be implemented through hardware, software, and/or firmware. Further, the number of components in application status system 100 is not limited to what is illustrated.

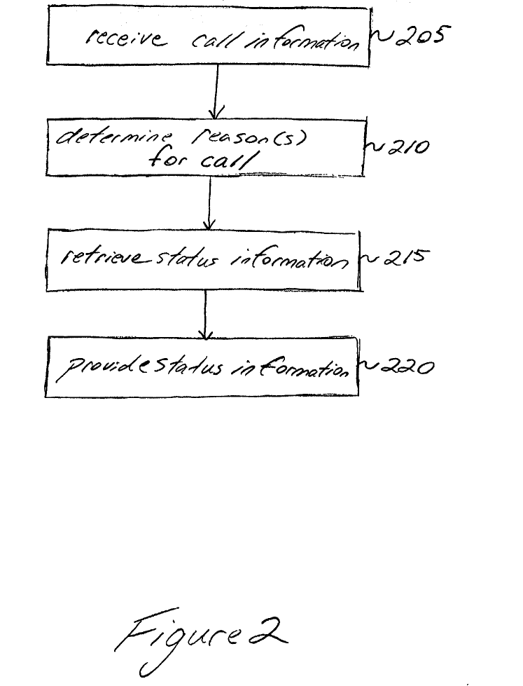

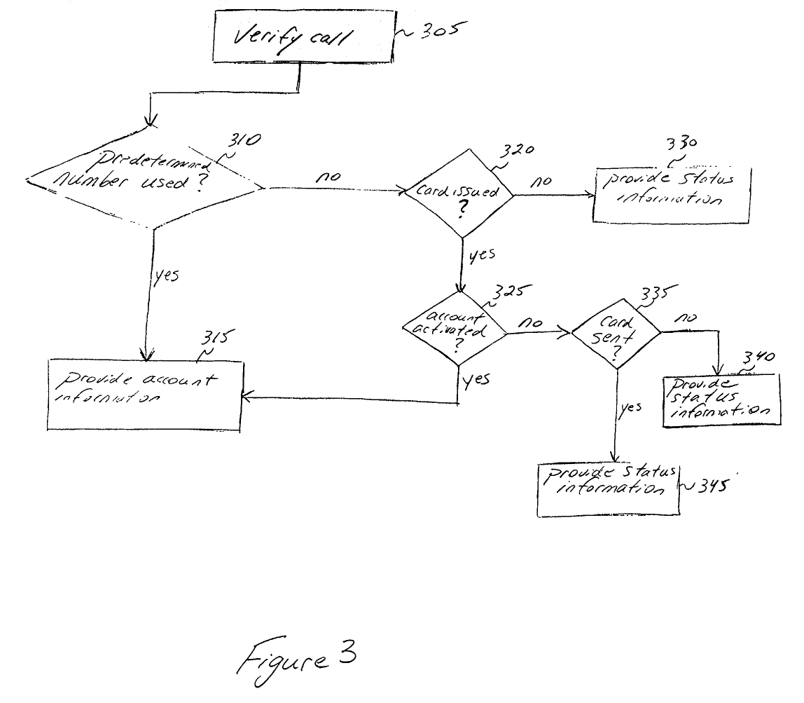

FIGS. 2 and 3 illustrate exemplary flow diagrams whereby status information is provided to an applicant via one or more automated messages after the applicant has submitted a credit card application.

An applicant, such as one of applicants 105a . . . 105n shown in FIG. 1, first submits information for a credit card application, for example, by telephoning a credit card company and verbally providing to a customer service representative the necessary information or sending a completed credit card application via mail or via e-mail to the credit card company. Information indicating that the applicant has submitted an application is stored in memory unit 120.

Thereafter, the applicant again contacts the credit card company, for example, by telephoning the credit card company via a 1(800) number, to inquire about the status of the previously submitted application. Specifically, the applicant may desire status information indicating whether the application has been received, whether the application has been approved and for how much money, for example, the credit limit, whether the account associated with the application has already been activated, if the account has not been activated, what is the reason or reasons for the account not being activated and how does the applicant rectify the reason(s), and/or whether a credit card was sent to the applicant and the date the applicant should receive the credit card. In an exemplary embodiment, the status information is automatically provided to the applicant via response unit 110 using one or more automated messages. Additional status information can be stored in memory unit 120 and automatically provided to the applicant using one or more automated messages.

Upon the applicant contacting the credit card company, response unit 110 receives call information associated with the telephone call by the applicant, in 205. For example, the applicant calls the credit card company and accesses response unit 110 using a telephone number printed on the application, displayed on a website of the company and/or printed on other literature of the company. Response unit 110 receives the call information and determines that the applicant called using a particular telephone number. The applicant can contact the credit card company and interact with voice response unit 110 in ways other than by placing a telephone call, for example, by interacting over the Internet.

Processing unit 125, and more particularly determination unit 115, coupled to response unit 110 then determines from the received call information the likely reason or reasons for the telephone call by the applicant, in 210. Specifically, in an exemplary embodiment, determination unit 115 determines whether a particular telephone number was used by the applicant or not used by the applicant. For example, determination unit 115 determines from the call information that the applicant did not call using a 1(800) number printed on a credit card. Rather, the applicant may have called using a 1(800) number printed on the application itself. As a result, determination unit 115 determines that the applicant is likely calling about the status of the application since it appears that applicant has not yet received a credit card. Otherwise, the applicant would have likely called the credit card company using a telephone number printed on the credit card. The call information can include any predetermined number, such as a predetermined account number, a predetermined number associated with the application and/or a card number, and, thus, the present application is not limited to using a predetermined telephone number to determine the likely reason for an applicant contacting the company. In an alternative embodiment, determination unit 115 determines a reason for the call based on the type of call information and/or the telephone number that the applicant used to call into response unit 110. The call information can also include a customer identifier that uniquely identifies the customer such as a social security number or an application number of the submitted application.

Once determination unit 115 determines the identity of the applicant and that a likely reason for the telephone call by the applicant is that the applicant is inquiring about the previously submitted application, in 210, determination unit 115 retrieves status information stored in memory unit 120 and associated with the application, in 215. In an exemplary embodiment, the status information associated with the application is retrieved by referencing a predetermined number input by the applicant. The predetermined number can include a social security number, a unique identifier assigned to a customer, date of birth, a zip code, a telephone number and any other unique identifier, or any combination thereof. In addition, the status information can include, for example, information indicating whether the application has been received, whether the application has been approved and for how much money, whether the credit card has been issued, whether additional funds are needed and if so the amount of the additional funds, whether the account associated with the credit card is activated, whether the credit card was sent to the applicant and the date the credit card was mailed or should be mailed, and other account information such as account balance information. After the status information is retrieved by determination unit 115, some or all of the status information is then automatically provided to the applicant via one or more automated messages depending on the current status of the previously submitted application, in 220.

FIG. 3 illustrates an exemplary flow diagram for providing application status information to an applicant of the present application. In an exemplary embodiment, when the applicant calls the credit card company to inquire about the status of a previously submitted application, the telephone call is first verified and the applicant is identified, in 305. The call is verified, for example, by matching an applicant input, such as a social security number, a unique identifier assigned to the applicant, date of birth, a zip code, a telephone number and any other unique identifier, or any combination thereof, with information stored in memory unit 120. Next, determination unit 115 determines a likely reason for the telephone call. In particular, determination unit 115 determines from call information received by response unit 110 whether a predetermined number was used by the applicant, in 310. In an exemplary embodiment, the predetermination number can be a particular telephone number that was used by the applicant or not used by the applicant and/or a credit card number or a number associated with the application that was inputted by the applicant. The present application is not limited to examining particular telephone numbers used or not used and/or credit card numbers or other numbers inputted. Rather, additional information can be utilized by determination unit 115 to predict whether the applicant is likely calling about the status of a previously submitted application. For example, information indicating whether a credit card has already been sent to an applicant, a date a credit card was sent, whether an application is complete and/or a date an application was sent to a credit card company, or any combination thereof.

If determination unit 115 determines from the call information that applicant used a predetermined number, for example, a 1(800) telephone number printed on a credit card sent to the applicant, in 310, account information, such as account balance information, stored in memory unit 120 is automatically provided to the applicant via one or more automated messages, in 315. Further, an automated menu having multiple entries can be automatically provided to the applicant, in 315, 330, 340 and/or 345. Some exemplary entries of the automated menu can be associated with a credit limit increase, an unsecured account, selecting a PIN (personal identification number), a payment address, a credit card balance, check by phone payment, express payment options, last/next payment, security deposit information, such as a balance and getting slips, closing an account, lost/stolen credit cards, earned interest and deposit information.

If determination unit 115 determines from the call information that a predetermined number was not used by the applicant, in 310, for example, the applicant called the credit card company using a telephone number printed on the application itself, determination unit 115 next determines whether the credit card has issued by accessing status information stored in memory unit 120, in 320. In an exemplary embodiment, a credit card issuing means an application associated with the credit card has been approved and the credit card has been sent to an applicant or will be sent the applicant. If it is determined that the credit card has issued, in 320, determination unit 115 then determines whether an account associated with the application has been activated by accessing status information stored in memory unit 120, in 325. An account may be activated, for example, by an applicant calling the credit card company and speaking with a customer service representative and/or by interacting with a voice response unit by inputting a predetermined number. Upon determination unit 115 determining that the account is activated, in 325, account information, such as account balance information, stored in memory unit 120 is automatically provided to the applicant via one or more automated messages, in 315. Further, an automated menu having multiples entries can be automatically provided to the applicant, in 315.

In 320, if determination unit 115 determines that the credit card has not issued, determination unit 115 retrieves status information stored in memory unit 120 and automatically provides the status information through response unit 110 to the applicant via one or more automated messages, in 330. In an exemplary embodiment, the status information can include information indicating that the application has or has not been received, a reason(s) why a credit card has not issued and what needs to be done to remedy the reason(s), and when the applicant may receive the credit card. Reasons for the credit card not issuing can include not receiving the application and additional information is needed. Further, if the application is associated with a secured credit card, a reason can include that additional funds for a security deposit are needed and if so, the amount of the additional funds, and deposit information. For example, a credit card may have to be secured by the applicant by having the applicant pay a predetermined amount of money, referred to herein as a security deposit, to the credit card company before the credit card is activated by the credit card company.

Further, in 325, if determination unit 115 determines that the account associated with the application is not activated from status information stored in memory unit 120, determination unit 115 then determines whether the credit card has been sent to the applicant, in 335. Determination unit 115 accesses status information stored in memory unit 120 to determine whether the credit card has already been sent to the applicant, if the credit card has not been sent, the date the credit card should be mailed to the applicant by the credit card company, and if the credit has already been sent, the date the credit card was mailed. In an exemplary embodiment, the date that the credit card should be mailed is determined by adding a number of days for processing an application based on historical data to the date an application was received by the credit card company. An additional number of days can then be added to the calculated number of days allowing for a margin of error.

If determination unit 115 determines from the status information that the credit card was sent to the applicant, in 335, determination unit 115 automatically provides to the applicant through response unit 110 status information via one or more automated messages, in 345. For example, the status information includes information indicating that the application has been processed by the credit card company and/or the date the credit card was mailed to the applicant. Other status information can be automatically provided to the applicant as well. On the other hand, if determination unit 115 determines from the status information that the credit card was not sent to the applicant, in 335, determination unit 115 automatically provides to the applicant status information via one or more automated messages, in 340. In an exemplary embodiment, such status information includes information indicating that the application has been processed and the date the credit card should be mailed to the applicant by the credit card company. Other status information can also be provided to the applicant via one or more automated messages.

Even though the exemplary embodiments were described with reference to an applicant submitting an application and later contacting a company by placing a telephone call, the present application is not meant to be limited to merely using a telephone. Rather, the applicant can submit one or more applications and thereafter contact the necessary company or companies using any communication method, such as by using the Internet via a personal computer, wireless telephone and/or personal digital assistant, or in-person.

The embodiments described above are illustrative examples of the present invention and it should not be construed that the present invention is limited to these particular embodiments. Various changes and modifications may be effected by one skilled in the art without departing from the spirit or scope of the invention as defined in the appended claims.

What is claimed is:

1. A method for managing a status of an application previously submitted by an applicant, comprising:
receiving call information associated with a call;
determining whether a reason for the call is to inquire about the status of the previously submitted application based on the call information;
retrieving status information associated with the applicant; and
automatically providing to the applicant from the retrieved status information a message indicating the status of the previously submitted application if it is determined that the reason for the call is to inquire about the status of the previously submitted application.

2. The method for managing a status of an application previously submitted by an applicant as set forth in claim 1, wherein
the step of determining includes determining a telephone number that the customer used to call into the voice response unit.

3. The method for managing a status of an application previously submitted by an applicant as set forth in claim 1, further comprising:
determining from the retrieved status information whether a card has been issued to the customer, wherein
the step of providing provides a reason for non-issuance of the card if it is determined that the card has not been issued.

4. The method for managing a status of an application previously submitted by an applicant as set forth in claim 1, further comprising:
determining from the retrieved status information whether a card has been sent to the customer, wherein
the step of providing provides a date the card was sent if it is determined that the card has been sent.

5. The method for managing a status of an application previously submitted by an applicant as set forth in claim 1, wherein
the call is a telephone call.

6. The method for managing a status of an application previously submitted by an applicant as set forth in claim 5, wherein
the previously submitted application is a credit card application.

7. The method for managing a status of an application previously submitted by an applicant as set forth in claim 6, wherein
the call information includes one of a predetermined telephone number used by the applicant, a predetermined card number associated with a credit card account and a predetermined number associated with the credit card application.

8. The method for managing a status of an application previously submitted by an applicant as set forth in claim 5, wherein
the previously submitted application is a loan application.

9. The method for managing a status of an application previously submitted by an applicant as set forth in claim 8, wherein
the call information includes a predetermined telephone number used by the applicant and a predetermined number associated with the loan application.

10. The method for managing a status of an application previously submitted by an applicant as set forth in claim 5, wherein
the status information includes at least one of information indicating whether the previously submitted application has been received, information indicating whether the previously submitted application has been approved, information indicating whether additional funds are needed, information indicating whether the previously submitted application has been processed, information indicating whether a card was issued, information indicating whether an account associated with the previously submitted application has been activated and information indicating a date the card should be mailed to the applicant or a date the card was mailed to the applicant.

11. A system for managing a status of a previously submitted application, comprising:
a memory unit for storing status information associated with the previously submitted application;
a response unit operable to receive call information associated with a call; and
a determination unit connected to the response unit and to the memory unit, the determination unit operable to receive the call information from the response unit for determining a reason for the call, the reason being to inquire about the status of the previously submitted application, to retrieve the status information associated with the previously submitted application from the memory unit, and
to automatically provide through the response unit a message indicating the status of the previously submitted application.

12. The system for managing a status of a previously submitted application as set forth in claim 11, wherein
the call is a telephone call.

13. The system for managing a status of a previously submitted application as set forth in claim 12, wherein
the status information includes at least one of information indicating whether the previously submitted application has been received, information indicating whether the previously submitted application has been approved, information indicating whether additional funds are needed, information indicating whether the previously submitted application has been processed, information indicating whether a card was issued, information indicating whether an account associated with the previously submitted application has been activated and information indicating a date the card should be mailed to the applicant or a date the card was mailed to the applicant.

14. The system for managing a status of a previously submitted application as set forth in claim 12, wherein
the previously submitted application is a credit card application.

15. The system for managing a status of a previously submitted application as set forth in claim 12, wherein
the previously submitted application is a loan application.

16. A method for providing status information to a customer calling into a voice response unit, comprising:
receiving a customer identifier that identifies the customer;
determining whether a reason for the call is to inquire about a status of a previously submitted application;
retrieving status information of the customer identified by the customer identifier;
providing a status of an account according to the retrieved status information if it is determined that the reason for the call is to inquire about the status of the previously submitted application.

17. The method for providing status information to a customer calling into a voice response unit as set forth in claim 16, wherein
the step of determining includes determining a telephone number that the customer used to call into the voice response unit.

18. The method for providing status information to a customer calling into a voice response unit as set forth in claim 16, further comprising:
determining from the retrieved status information whether a card has been issued to the customer, wherein
the step of providing provides a reason for non-issuance of the card if it is determined that the card has not been issued.

19. The method for providing status information to a customer calling into a voice response unit as set forth in claim 16, further comprising:
determining from the retrieved status information whether a card has been sent to the customer, wherein
the step of providing provides a date the card was sent if it is determined that the card has been sent.
